(19) United States
(12) Patent Application Publication
(10) Pub. No.: US 2007/0045285 A1
(43) Pub. Date: Mar. 1, 2007

(54) Automatic heating apparatus

(76) Inventor: He-Ping Chen, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/246,084

(22) Filed: Oct. 11, 2005

(30) Foreign Application Priority Data
Aug. 30, 2005 (TW) 94129718

(51) Int. Cl. H05B 1/02

(52) U.S. Cl. 219/497

(57) ABSTRACT

The present invention provides an automatic heating apparatus. The automatic heating apparatus uses a plurality of resistors and a heat conductor to solve the problems encountered when a complex heating circuit of the prior art needs to be operated in a low temperature environment and therefore requires an automatic heating effect. The automatic heating apparatus can be located on a surface of an electronic component or on one side of an electronic device to increase the temperature of the electronic component or the electronic device.

### BACKGROUND OF THE INVENTION

1. Field of the Invention

The present invention relates to an automatic heating apparatus. The automatic heating apparatus is designed to operate in low temperature environments to make an electronic device work normally.

2. Description of the Related Art

Because a lot of electronic devices need to operate at a specific temperature (such as room temperature), they will fail in low temperature environments. If the electronic devices operate at a specific temperature, the electronic components cannot work. For example, network apparatuses or radial transmission stations are located outdoors. When the temperature is under −5° C., all components of the apparatus cannot work normally.

For solving this problem, some complex circuits are added to the electronic devices to make the electronic components of the electronic devices work normally at low temperatures. Alternatively, a keep-warm cover is placed around the outside of electronic devices to keep the electronic components of the electronic devices working normally.

Although the described solutions can solve the problem, the circuits involved are complex and expensive.

### SUMMARY OF THE INVENTION

One particular aspect of the present invention is to provide an automatic heating apparatus. The automatic heating apparatus have the ability to emit heat when resistors are overloaded and combine with a heat conductor to form an apparatus that can automatically heat an electronic device.

The present invention provides an automatic heating circuit. The automatic heating circuit includes a power supply, a first transistor, a heating circuit, a second transistor and a heat conductor. The power supply is used for providing voltage for the automatic heating circuit. The emitter of the first transistor is electrically connected with the power supply. The heating circuit is composed of a plurality of resistors that are connected in parallel. One end of the resistors is connected with the collector of the first transistor. Another end of the resistors is grounded. The collector of the second transistor is electrically connected with the base of the first transistor. The emitter of the second transistor is electrically connected with a first resistor and a second resistor. The heating conductor is electrically connected with the base of the second transistor and a third resistor.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a circuit diagram of the automatic heating circuit of the present invention;

FIG. 2 is a schematic diagram of the automatic heating apparatus of the first embodiment of the present invention;

FIG. 3A is a schematic diagram of the front side of the circuit board of the automatic heating apparatus of the second embodiment of the present invention; and

FIG. 3B is a schematic diagram of the back side of the circuit board of the automatic heating apparatus of the second embodiment of the present invention.

### DETAILED DESCRIPTION OF THE PREFERRED EMBODIMENTS

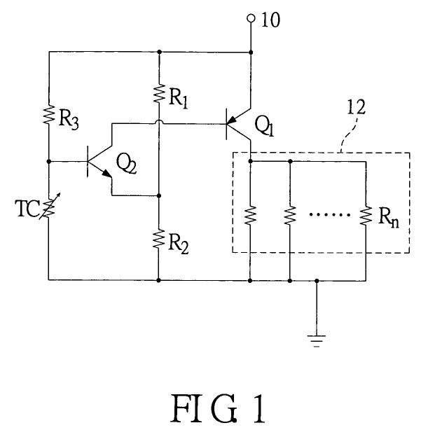

Please refer to FIG. 1, which shows a circuit diagram of the automatic heating circuit of the present invention. The automatic heating circuit includes a power supply 10, a first transistor Q1, a heating circuit 12, a second transistor Q2 and a heat conductor TC. The power supply 10 is used for providing voltage for the automatic heating circuit. The power supply 10 is a voltage source or a current source. The power supply 10 is provided by an electronic device. The range of the supply voltage depends upon the voltage specification of the electronic device. The emitter of the first transistor Q1 is electrically connected with the power supply 10. The heating circuit 12 is composed of a plurality of resistors Rn that are connected in parallel. One end of the resistors Rn is connected with the collector of the first transistor Q1. Another end of the resistors Rn is grounded. The quantity of the resistors Rn depends on the heating energy. The collector of the second transistor Q2 is electrically connected with the base of the first transistor Q1. The emitter of the second transistor Q2 is electrically connected with a first resistor R1 and a second resistor R2. The heating conductor TC is electrically connected with the base of the second transistor Q2 and a third resistor R3. The heating conductor TC is used for adjusting the current flowing through the emitter of the first transistor Q1.

The operation of the automatic heating circuit is described as follows. The heating conductor TC detects the environmental temperature and checks whether the temperature is under 0° C. When the environmental temperature is under 0° C., the heating conductor TC increases the base voltage VB of the second transistor Q2. According to voltage divider theorem, the base current IB of the second transistor Q2 is obtained via a transfer formula. The base voltage VB of the second transistor Q2=VCC (supply voltage)*TC (heating conductor value)/(R3+TC) (resistance of the third resistor+resistance of the heating conductor). After the base voltage VB of the second transistor Q2 is obtained, the base voltage VB is divided by a resistance of the third resistor R3 to obtain a base current IB of the second transistor Q2. Then, collector current (I_{C2}=I_{B1}) of the second transistor Q2 is obtained via I_{C}=β*I_{B}.

By using I_{C}=β*I_{B} and I_{C}≈I_{E}, because the collector of the second transistor Q2 is electrically connected with the base of the first transistor Q1, a collector current I_{C1} of the first transistor Q1 is obtained. The collector current I_{C1} of the first transistor Q1 multiplied resistance of the resistor Rn of the heating circuit is a collector voltage of the first transistor Q1. The collector voltage is continuously imposed to the resistors until the overloading voltage of the resistors is reached. Because the overloading voltage has been calculated, the voltage will heat the resistors, yet won't burn down the resistors. According to the formula P_{R}=W_{P}=V²/R, the consumed power is proportional to the voltage when the resistance of the resistors of the heating circuit is fixed. Therefore, the consumed power is increased by adjusting the heating conductor to make the collector current of the first transistor increase. The present invention makes the resistors warm up to heat the electronic device and distribute the heat around the electronic device or the electronic components.

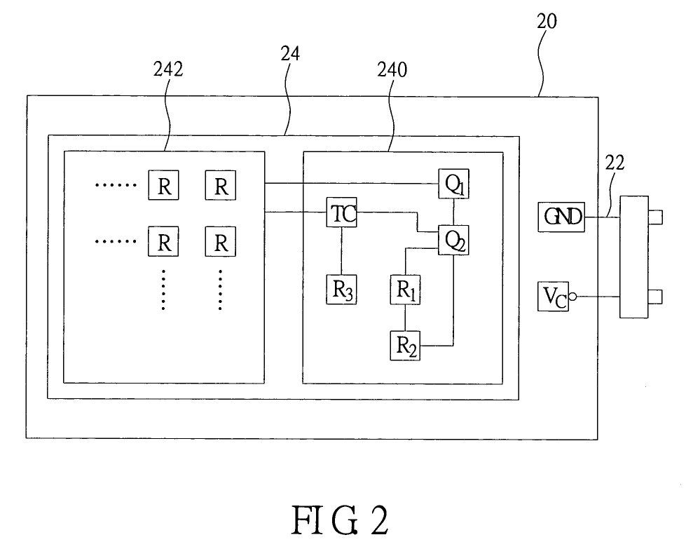

Please refer to FIG. 2, which shows a schematic diagram of the automatic heating apparatus of the first embodiment of the present invention. The automatic heating apparatus includes a power supply, a circuit board 20 and an automatic heating circuit 24. The power source of the supply power is transmitted to the circuit 20 via an electrical power transmission line 22. The automatic heating circuit 24 is located on the circuit board 20 and obtains its power source from the power supply. The automatic heating circuit 24 includes a power source control circuit 240 and a heating circuit 242. The power source control circuit 240 and the heating circuit 242 are located at the same side of the circuit board 20. The heating circuit 242 is composed of a plurality of resistors Rn (R as shown in FIG. 2) that are connected in parallel. One end of the resistors Rn is connected with the collector of the first transistor. Another end of the resistors Rn is grounded. The quantity of the resistors Rn depends on the heating energy.

The power source control circuit 240 further includes a first transistor Q1, a second transistor Q2 and a heat conductor TC. The emitter of the first transistor Q1 is electrically connected with the power supply. The collector of the second transistor Q2 is electrically connected with the base of the first transistor Q1. The emitter of the second transistor Q2 is electrically connected with a first resistor R1 and a second resistor R2. The heating conductor TC is electrically connected with the base of the second transistor Q2 and a third resistor R3. The heating conductor TC is used for adjusting the current flowing through the emitter of the first transistor Q1. Thereby, the automatic heating circuit 24 is continuously heated according to the current flowing through the emitter of the first transistor Q1.

The automatic heating apparatus of the present invention is located on a surface of an electronic component or on one side of an electronic device to increase the temperature of the electronic components or the electronic device. When the automatic heating apparatus is located on the surface of an electronic component, a heat-conducting adhesive is coated on the surface of an electronic component to make the automatic heating apparatus attach tightly onto the electronic component.

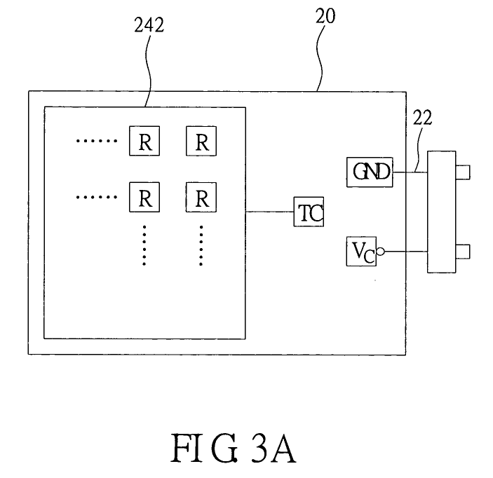

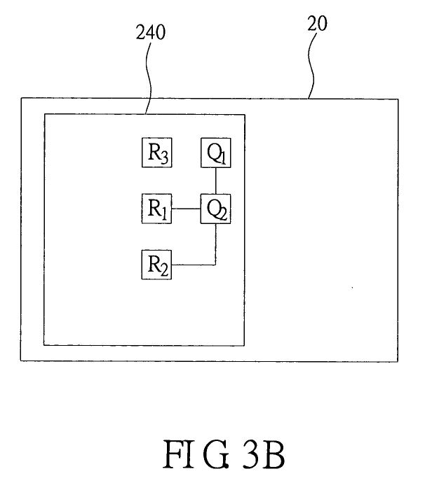

Please refer to FIGS. 3A and 3B. FIG. 3A is a schematic diagram of the front side of the circuit board of the automatic heating apparatus of the second embodiment of the present invention. FIG. 3B is a schematic diagram of the back side of the circuit board of the automatic heating apparatus of the second embodiment of the present invention. The difference between the first embodiment and the second embodiment is that the power source control circuit 240 and the heating circuit 242 are located at different sides of the circuit board 20.

The automatic heating apparatus of the present invention uses the heating conductor to automatically detect the environmental temperature and warms up by itself. When the environmental temperature is under −5° C., the heating conductor uses the heating circuit to warm up the electronic device. The lower the environmental temperature, the higher the heat produced by the heating circuit. Therefore, the heating circuit is a heating element at low temperatures. When the environmental temperature is between −5° C. and 60° C., the heating circuit is open and performs no heating operations. At this time, the heating circuit acts as a heat sink element.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An automatic heating circuit, comprising:
a power supply, used for providing voltage for the automatic heating circuit;
a first transistor, an emitter of the first transistor is electrically connected with the power supply;
a heating circuit, composed of a plurality of resistors that are connected in parallel, one end of the resistors is connected with the collector of the first transistor and another end of the resistors is grounded;
a second transistor, a collector of the second transistor is electrically connected with the base of the first transistor, an emitter of the second transistor is electrically connected with a first resistor and a second resistor, and;
a heat conductor, electrically connected with the base of the second transistor and a third resistor.

2. The automatic heating circuit as claimed in claim 1, wherein the heating conductor is used for adjusting the current flowing through the emitter of the first transistor.

3. The automatic heating circuit as claimed in claim 1, wherein the quantity of the resistors depends on the heating energy.

4. An automatic heating apparatus, comprising:
a power supply;
a circuit board, a power source of the supply power is transmitted to the circuit via an electrical power transmission line; and
an automatic heating circuit, located on the circuit board, obtains the power source from the power supply.

5. The automatic heating apparatus as claimed in claim 4, wherein the automatic heating circuit includes a power source control circuit and a heating circuit.

6. The automatic heating apparatus as claimed in claim 5, wherein the power source control circuit and the heating circuit are located on the same side of the circuit board.

7. The automatic heating apparatus as claimed in claim 5, wherein the power source control circuit and the heating circuit are located on different sides of the circuit board.

8. The automatic heating apparatus as claimed in claim 5, wherein the power source control circuit further comprises:
a first transistor, an emitter of the first transistor is electrically connected with the power supply;
a second transistor, a collector of the second transistor is electrically connected with the base of the first transistor, an emitter of the second transistor is electrically connected with a first resistor and a second resistor, and; and
a heat conductor, electrically connected with the base of the second transistor and a third resistor.

9. The automatic heating apparatus as claimed in claim 8, wherein the heating conductor is used for adjusting the current flowing through the emitter of the first transistor.

10. The automatic heating apparatus as claimed in claim 8, wherein the heating circuit is composed of a plurality of resistors that are connected in parallel, one end of the resistors is connected with the collector of the first transistor and another end of the resistors is grounded.

11. The automatic heating apparatus as claimed in claim 10, wherein the quantity of the resistors depends on the heating energy.

12. The automatic heating apparatus as claimed in claim 5, wherein the automatic heating apparatus is located on a surface of an electronic component or on one side of an electronic device to increase the temperature of the electronic component or the electronic device.

13. The automatic heating apparatus as claimed in claim 12, wherein a heat-conducting adhesive is coated on the surface of an electronic component when the automatic heating apparatus is located on the surface of an electronic component.
